(19) United States
(12) Patent Application Publication
(10) Pub. No.: US 2018/0073805 A1
(43) Pub. Date: Mar. 15, 2018

(54) Multiple Belt and Multiple Zone Textile Dryer

(71) Applicant: M&R Printing Equipment, Inc., Roselle, IL (US)

(72) Inventors: Richard C. Hoffman, JR., Lake Forest, IL (US); Mariusz Switalski, Des Plaines, IL (US); Darek Tkacz, Naperville, IL (US)

(21) Appl. No.: 15/264,277

(22) Filed: Sep. 13, 2016

(51) Int. Cl. F26B 3/04; F26B 13/10; F26B 13/12; F26B 15/18; F26B 25/14

(52) U.S. Cl. CPC F26B 3/04; F26B 13/108; F26B 25/14; F26B 15/18; F26B 13/12

(57) ABSTRACT

The present invention provides a textile dryer having a housing defining a chamber having an infeed and an outfeed. A separation wall extends through the chamber to create a first zone having a first ambient condition and a second zone having a second ambient condition. A first conveyor extends through the first zone and a second conveyor extends through the second zone. A controller is provided to allow an operator to independently select the speed and direction of the first conveyor and the second conveyor, and to independently select the physical conditions of the first ambient condition and the second ambient condition, and to maintain these settings during the operation of the dryer.

### CROSS-REFERENCE TO RELATED APPLICATIONS

N/A

### FEDERALLY SPONSORED RESEARCH OR DEVELOPMENT

N/A

### FIELD OF THE INVENTION

The present invention generally relates to a textile dryer having multiple conveyor belts each extending in a direction parallel to one another and with an operating speed and direction of each belt independently controllable. The present invention further provides a textile dryer having multiple zones of ambient conditions (temperature, humidity, pressure, air flow rate(s), exposure to electromagnetic radiation of a particular frequency, and other physical conditions) that are independently controllable. The present invention further comprises a combination of the former two such that each conveyor is associated with its own zone of ambient conditions.

### BACKGROUND OF THE INVENTION

Screen printing is an art form that is thousands of years old and involves depositing ink on a screen with a pattern thereon and squeegeeing the ink so that it passes through the screen onto the item to be screened. Screen printing is commonly used for decorating clothing such as T-shirts, pants, and other items like hand bags and totes. Boutiques which specialize in printing fanciful indicia such as ornamentation, slogans, college names, or sports team names on T-shirts and other clothing are commonly seen in shopping malls. The indicia available at these boutiques can be pre-printed on a substrate and applied to articles of clothing purchased by the consumer with a heated press by boutique operators, or can be applied directly to an article of clothing. The indicia can include either simple one-color block letters or elaborate multi-color illustrations.

In common use in the silk screening industry are multi-station turret type (U.S. Patent Publication No. 2011/0290127) and oval-type (U.S. Patent Publication No. 2010/0000429) printing presses (both of these patent applications are incorporated herein by reference and made a part hereof). These printing presses have a plurality of flat beds or platens spaced along their perimeter, one for each color. The number of stations employed depends on the number of colors to be printed on the object. Indicia can consist of up to ten colors or more.

One significant challenge in screen printing is the time necessary to prepare each screen. The general process for setting-up the screens for printing follows:

First, the artwork is set up. The artwork, in the form of a film positive, is secured on a layout board. Next, a carrier sheet (optically clear polyester film) is placed on the layout board. An individual separates the colors by transferring the artwork by hand to one or more carrier sheets. In this separation/transference process, each carrier sheet represents a separate color to be used in the final screened textile. Thus, if there are six colors being screened, there will be six carrier sheets (art separations) completed.

Second, the stenciled screens are made (one for each color or print head). The indicia or design is formed in the screen by a conventional process. The mesh of the screen is generally covered with an ultraviolet sensitive emulsion and put into a vacuum exposure unit, basically having a light source, a vacuum, a cover, and a table disposed therebetween. Each carrier sheet is aligned with an emulsion covered, pre-stretched screen such that the carrier sheet is disposed between the light source and the screen. The cover is closed and the screen/carrier sheet combination is subjected to a vacuum, to bring them into contact with one another, and UV light. The exposed screen is then chemically processed resulting in a printing screen. With modern techniques and chemicals, processing can be performed by applying a high power water spray to the exposed screen.

When exposed to ultraviolet (UV) light and processed (often by a power water spray), those portions or mesh of the screen covered (such as by stencil) are left open (interstices are formed), permitting light, paint, or ink to pass through the mesh. Those portions of the screen mesh not covered by a stencil, once exposed and processed, become opaque, blocking the passage of light, paint, or ink through the mesh.

Specifically, those parts of the mesh not exposed to the UV light (the unexposed stencil/design) wash away and produce openings or interstices in the mesh for the ink to pass therethrough during the printing process. The interstices in screen represent the places where ink of a particular color is to be deposited onto the textile or other substrate.

Third, each printing screen is secured to a printing head. One color of ink is then placed into each printing head.

The textiles, one at a time, are loaded onto the travelling pallets and the pallets travel to each of the printing stations, each station having a different color of ink therein. The ink is applied to each textile through the screen at each station. Each textile is cured and the ink permitted to set.

One attempt to speed the screen preparation process is a direct to screen (DTS) machine disclosed in commonly assigned U.S. Patent Publication No. 2014/0261029 which is incorporated herein by reference and made a part hereof. Even with DTS (direct to screen) machines, it can require 10-20 minutes to prepare each screen.

One alternative to screen printing is DTG (direct to garment) digital printers with piezo heads. These DTG machines have the advantage of being able to separate the colors from a digital file loaded onto a computer controller of the machine, and then simply spraying the colors onto the garment through piezo heads. The limitation is that the piezo heads can be extremely slow when compared to screen printing, so it has not been economical to use DTG printing machines for large run garment jobs, nor to mix digital printers in with screen printing machines because it slows the screen printing press down by about a factor of one-half to two-thirds.

Also, most garment prints require an under base, which is generally white or very light. Getting enough white pigment through the piezo heads to do the under base, especially on a dark garment that requires a heavy coat, has been and is still very difficult. This has further delayed the wide-spread use of digital printing of textiles.

In one commonly assigned and copending provisional patent application No. 62/205,416 discloses a hybrid printing press combining screen printing with DTG printing which is incorporated herein by reference and made a part hereof. The hybrid machine combines the positive attributes of silk screening and digital printing by dedicating the screen printing process to applying the white or light under base, and dedicating the digital printing to the other colors. Thus, far fewer screens will be required which will result in a significant time savings. The digital printer will be dedicated to applying much smaller volumes of ink and by using a large number of print heads, the speed of the digital printer can match the speed of the silk screening.

There are several types of ink that are used for textile printing including water-based inks, plastisols and sublimation inks. Water-based inks utilize either dyes or pigments in a suspension with water as the solvent. The evaporation of the water is necessary to set or cure the ink. This curing can take place either at room temperature or using a forced-air dryer depending upon the specific water-based ink used and the speed or volume of production. While water-based inks are defined as those that utilize water as the main solvent, they can contain co-solvents which are petroleum based. Many water-based inks can also be more quickly cured with the addition of a catalyst. The disadvantage of a catalyst is that once it is added to a water-based ink, it creates a time limit or pot life where the ink must be all used in a certain time or be discarded.

Plastisol inks contain poly(vinyl chloride) and little or no solvent. Along with UV inks used in graphic screen printing, it is referred to as a 100% solid ink system. Plastisol inks are cured by exposure to temperatures in the range of about 320° F. to about 350° F. for a period of five to ten minutes or more which causes PVC to crosslink and solidify. In the ranges below 320 degrees and above 350 degrees, the plastisol will not properly set, resulting in cracking, or it may become liquefied. Moreover, if a dye in the textile is overheated, it will migrate, or the textile or substrate may scorch or burn, increasing waste and production costs. Plastisol inks are available in various opacities with the most opaque being the most expensive, mainly due to the cost of the increased pigment.

Water based inks containing acrylics are also commonly used in screen printing and must be cured by exposure to heat for a period of time. Discharge inks are water-based inks for screen printing. The inks are mixed with an activator such as formaldehyde and a pigment and are used with cotton containing textiles and no base coat is required. Discharge inks are cured by heating to 320° F. for a sufficient period of time to evaporate the water and to discharge the ink into the fibers of the textile.

Sublimation inks are water based inks for direct to garment printing using a digital printer and have to be heated to cure the ink to about 320° F.

Forced air textile dryers are commonly used to cure textiles that have been screen printed or prepared by a direct-to-garment process. Such dryers are typically electric or gas-powered and have a single heating chamber operating at a selected temperature or a temperature range. Since curing temperatures and curing times can widely vary depending on the ink used to print on the textile, if a group of textiles printed using, for example, screen printing with plastisol inks, and a group of textiles printed in a direct-to-garment process using a water-based ink, these textiles must be dried separately from one another either using a single drier in consecutive operations, which is time consuming and expensive, or in two dryers simultaneously or consecutively which can be quite expensive due to the high price of a forced air textile dryer. The present invention overcomes this problem by providing a forced air textile dryer with two independently operated conveyor belts and a forced air textile dryer that has a heating chamber with two zones having independently controlled ambient conditions. By controlling the heat, humidity and dwell times in each zone, two batches of textiles printed with different inks with different cure times and temperatures can be run through the drying chamber simultaneously saving time and money.

### SUMMARY OF THE INVENTION

The present invention provides a textile dryer having a housing defining a chamber having an infeed and an outfeed. A separation wall extends through the chamber to create a first zone having a first ambient condition and a second zone having a second ambient condition. A first conveyor extends through the first zone and a second conveyor extends through the second zone. A controller is provided to allow an operator to independently select the speed and direction of the first conveyor and the second conveyor, and to independently select the physical conditions of the first ambient condition and the second ambient condition, and to maintain these settings during the operation of the dryer.

The present invention provides a textile dryer having a housing defining a chamber having an entrance and an exit and an ambient condition; a first and second conveyor extend through the chamber having a surface for supporting objects in exposure to the ambient condition; and a controller operatively coupled to the first conveyor and the second conveyor for independently controlling the speed of the first conveyor and the speed of the second conveyor.

The present invention further provides a textile dryer having a housing defining a chamber having an entrance and an exit and a separation wall for forming a first zone having a first ambient condition and a second zone having a second ambient condition. A controller allows a user or operator to select the physical characteristics that define the ambient condition and the controller maintains such conditions through control of inputs into the chamber such as the heat and humidity of air delivered to the chamber under pressure.

The present invention further provides a textile dryer having a housing defining a chamber having an infeed or entrance and an outfeed or exit and a separation wall for forming a first zone having a first ambient condition and a second zone having a second ambient condition. A controller allows a user or operator to select the physical characteristics that define the ambient condition and the controller maintains such conditions through control of inputs into the chamber such as heat and humidity. A first conveyor extends through the first zone and a second conveyor extends parallel to the first conveyor and through the chamber. The controller is coupled to the first conveyor and the second conveyor and allows a user or operator to set desired conveyor speeds or ranges of speeds for each conveyor independently. The controller maintains the set speeds by measuring the real speed and comparing for agreement with values in the specified range and speeding the conveyor if it is going too slow and slowing the conveyor if it is going too fast.

### BRIEF DESCRIPTION OF THE DRAWINGS

To understand the present invention, it will now be described by way of example, with reference to the accompanying drawings and attachments in which:

FIG. 1 is a perspective view of a multiple belt and/or a multiple zone textile dryer of the present invention;

FIG. 2 is a schematic view of an air flow diagram for the dryer of FIG. 1; and

FIG. 3 is a flowchart of a method of using a textile dryer of the present invention.

### DETAILED DESCRIPTION

While this invention is susceptible of embodiment in many different forms, there is shown in the drawings, and will be described herein in detail, specific embodiments thereof with the understanding that the present disclosure is to be considered as an exemplification of the principles of the invention and is not intended to limit the invention to the specific embodiments illustrated.

FIG. 1 shows a dryer assembly 10 having a housing 12 defining a chamber 14 therein and having a first conveyor system 16 and a second conveyor system 18 each extending through an infeed or entrance 20 into the housing and an outfeed or exit 22 from the housing. The terms “entrance” and “infeed” shall be used interchangeably as will the terms “exit” and “outfeed.” The housing 12 is formed of opposed side walls 32, opposed end walls 34, a top wall 36 and a bottom wall 38. Such walls and panels are generally constructed of sheet metal and optionally with a double wall construction surrounding a layer of insulative material to assist in keeping the outer walls relatively cool to the touch.

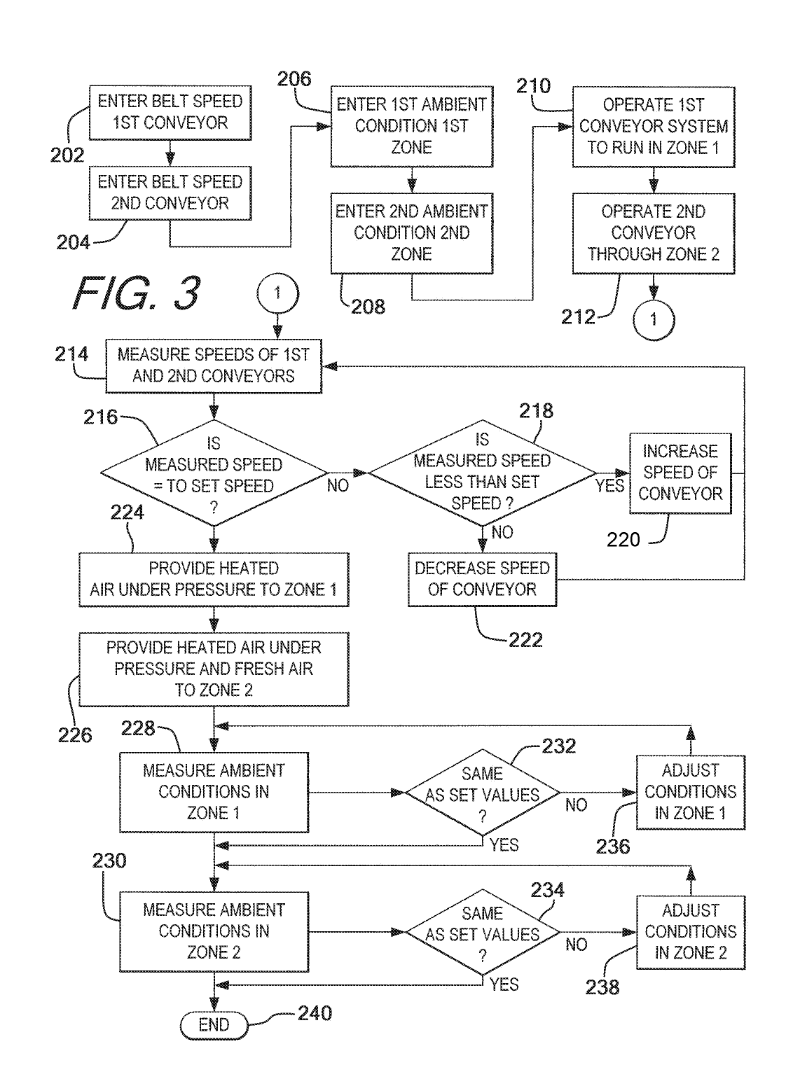

The chamber 14 has an ambient condition defined by physical characteristics such as temperature, humidity, pressure, air flow rate(s), exposure to electromagnetic radiation of a particular frequency such as ultra violet (UV) or infrared (IR), and other measurable physical conditions. An operator using a controller 24 having a suitable graphical user interface (GUI) can enter a desired value or a range of values for each physical condition used to constitute the ambient condition. The controller 24 will maintain the conditions in the chamber to define the desired ambient condition. The controller 24 has a processor, a memory, and computer readable instructions in the memory when executed by the processor takes the necessary steps to control the operation of the dryer to achieve a desired goal. The dryer is connected to other controls on valves, and blowers, for example, to moderate the flow rate, temperature, humidity of forced air supplied under pressure into and out of the chamber to maintain the set conditions. Additionally, the controller 24 is connected to a sensor or multiple sensors inside the chamber or dryer to measure and generate a signal representative of a physical characteristic such as temperature, humidity, air flow rate, etc., and sending the signal to the controller 24. As will be discussed below in reference to FIG. 3, the controller 24 compares the measured physical characteristic with the user inputted value or range of values and makes adjustments to the inputs or operating conditions to bring the measured characteristic within the desired range of values. The controller 24 can be electrically coupled to the sensors and controls by a physical connection such as a wire, through a wireless connection or a combination of wired and wireless connections. Wireless connections are well known to those of skill in the art and include any near field communication technology, Bluetooth, radio frequency and others.

In a preferred form of the invention, the first conveyor system 16 and the second conveyor system 18 extend parallel to one another, more preferably are coextensive (of the same length), and most preferably are coterminous (each of the opposed ends are in registration). Each of the first conveyor and the second conveyer systems 16,18 are mounted or journalled for reciprocal translational motion as shown by arrows 26 and each have an upper surface 27 for supporting objects and in exposure to the ambient condition of the chamber. Preferably, the upper surfaces are generally coplanar. In one form of the invention, the objects are freshly printed textiles where the ink is still wet or uncured and the ambient condition is set to dry the ink over a period of time the textiles are present in the chamber (dwell time). The dryer 10 shown has two conveyor systems but more than two conveyors such as from 2 to 5 can be provided without departing from the scope of the present invention. Each of the conveyors will be associated with a zone having an independently set ambient condition.

Each of the conveyor systems 16,18 preferably has a continuous belt 50,52 respectively supported on a frame (support rails), with the belts 50,52 having a highly porous (or open mesh) surface area, such as a screen, mounted around (entrained) at least two rollers supported by the frame as is well known in the art. The preferred belt is a heat-resistant, Teflon® coated fiberglass. The belts 50,52 are driven by a motor(s) (not shown) in the direction indicated by the arrows 26 so that the objects resting thereon, such as textiles, pass through the chamber 14 between the side walls 32 of housing 12 from the entrance 20 to the exit 22. FIG. 1 shows the belt 50 has a width greater than a width of the second belt 52 but the belts could be of the same or similar widths without departing from the present invention. In a preferred form of the invention a ratio of the widths of the second belt 52 to the first belt 50 is from 1:1 to 1:10, more preferably 1:1.1 to 1:5, and even more preferably from 1:1.5 to 1:3.

The continuous belts 50,52 of each of the conveyor systems 16,18 should be of sufficient width to carry objects of varying size with the wide belt 50 capable of supporting large textiles while the narrow belt 52 is capable of supporting smaller objects. The length of belts 50,52 are dictated by the size of dryer 10, but this length must be taken into consideration when independently setting the speed the belts 50,52 travel through housing 12. That is, a sufficient dwell time within the dryer 10 must be allowed for each printed article to reach the desired condition. The conveyors 50,52 generally extend beyond the entrance and exit openings 20,22 to points outside the housing 12.

In a preferred form of the invention, the dryer will use a belt tracking system on each of the conveyors so that the lateral edges of each conveyor move at the same speed. The belt tracking also allows the conveyor belts to change directions without causing the belt to lose tracking causing textiles to shift on the belt due to the lateral edges of the belt moving at different speeds. This overcomes a problem using crowned rollers which cannot reverse directions and maintain proper tracking. One suitable conveyor tracking system is disclosed in a commonly assigned U.S. patent Ser. No. 15/194,035 and a continuation-in-part application therefrom under docket number 292593-007273, both of which are incorporated herein by reference and made a part hereof. The tracking system includes an idle or drive roller of the conveyor belt having an annular guiding groove positioned radially inwardly from a lateral end and a bead is attached to the belt along an entire length of a lateral edge of the conveyor and rides within the groove so that the opposed lateral edges of the belt move at the same speed or they track one another. The direction of the conveyor can be reversed without losing tracking. If a conveyor belt loses tracking, an object on the conveyor will twist as one part of the textile is moving at a greater speed than another portion of the textile.

FIG. 1 shows a separation wall 60 extending longitudinally within the housing 12 to divide the chamber 14 into a first zone 62 and a second zone 64 with each zone having an ambient condition having physical conditions that can be independently set by the user with the GUI of the controller 24. The separation wall extends substantially from the entrance 20 to the exit 22 of the housing and is positioned between the first belt and the second belt 50,52 so that the first belt 50 extends through the first zone 62 and the second belt extends through the second zone 64. Preferably, the separation wall 60 is retractable from being fully deployed along substantially a full length of the housing to an intermediate position being partially deployed along a portion of the length of the housing or in a fully collapsed condition where the chamber has a single ambient condition. The separation wall 60 can be deployed and retracted manually or by a mechanism powered by a motive force such as a servo motor. The separation wall 60 can be stowed, in an extended condition or a collapsed condition, above or below the surface of the conveyor belts and can be moved vertically, up or down, into the desired position. The separation wall can also be stowed in the chamber in a collapsed condition or an extended position and moved horizontally into position in a direction transverse to the belt direction or in a direction parallel to the belt direction.

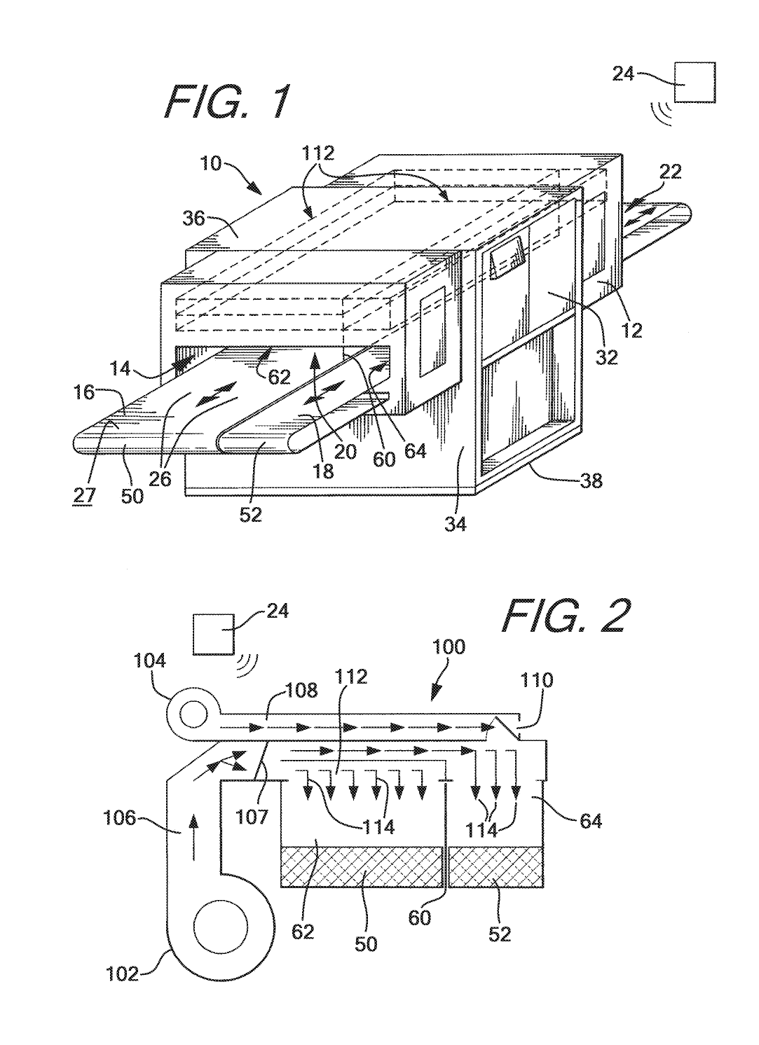

FIG. 2 shows an air distribution system 100 of the dryer 10 having a hot air blower 102, a fresh air blower 104, a hot air conduit 106, a hot air valve 107, a fresh air conduit 108 and a fresh air valve 110. Hot air is supplied under pressure to the first zone 62 and a mixture of hot air and fresh air is supplied to the second zone 64. The mixing percentages of the hot air and fresh air can be controlled through the fresh air valve 110 which is connected to the controller 24. Additionally, the hot air blower 102 and the fresh air blower 104 each has a control for varying the flow rate of heated or fresh air and the temperature of the air to achieve the desired temperature of the air. The flow of heated air to the first zone or a combination of heated and fresh air to the second zone is provided through a distribution channel 112 connected to a plurality of air knives 114 extending longitudinally above each belt and having separate channels horizontally spaced from one another to provide an even temperature across the length and width of the belts 50,52.

To operate the dryer a user or operator will select the desired physical characteristics to be maintained within the chamber or in zone 1 and zone 2, and additional zones if present, of the chamber. For example, the user will select a desired temperature or range of temperatures, humidity, air flow rate, conveyor belt speed, dwell time of an object to spend in the chamber, and the frequency of electromagnetic radiation if any to pass through the chamber. The dryer is powered up and objects are placed on the conveyor belts by an operator at the infeed and removed by an operator at the outfeed. Typically, textiles that have been printed with ink are placed in the dryer to dry or cure the ink. The ink can be dried or cured using the heated air but the ink could be cured by exposing the textiles to electromagnetic radiation such as UV or IR light. Each zone has its own ambient condition so that objects having differing sizes, differing initial conditions or different end conditions, for example, can be achieved using the dual or multiple zones having optimal conditions for the objects that pass through the dryer.

FIG. 3 shows a flowchart 200 of an exemplary method of using the textile dryer of the present invention. The steps do not have to be carried out in the exact order as shown. In steps 202,204 an operator will enter the desired belt speed of the first conveyor system and of the second conveyor system using the graphical user interface (GUI) of the controller. The controller will set and monitor the speed of the belts to achieve the desired dwell times to cure the ink. Each of the conveyor belts can be run in a single direction or back and forth in two directions to achieve the desired dwell time. Additionally, in one preferred form of the invention, the operator can specify the side of the dryer to initially load the textiles to be dried, and the end of the dryer where the cured textiles can be removed. The entrance side and the exit sides of the textile can be on the same side or different sides of the dryer.

In steps 206,208 an operator using the GUI will enter the physical conditions to define the first ambient condition of a first zone and the physical conditions to define a second ambient condition of a second zone. It is not necessary to provide heat to both zones—one zone can be heated while the other zone is unused and no heated air is supplied. Thus, the dryer can be operated as a single chamber with two belts operating at the same speed to act as a single, full-sized dryer, or one conveyor can operate while the other conveyor is stationary to operate as a single dryer of lesser size than the full-sized dryer, and both conveyors can be operated through two different zones to act as two dryers.

Once the operating conditions of the dryer are entered, an operator using the controller can, in steps 210,212, initiate the running of the first conveyor through the first zone and the second conveyor through the second zone. Periodically, the speed of each conveyor is measured 214 and reported to the controller which compares at step 216 the actual speed of the conveyors with the set speed. If the measured speed is not equal then it is determined at step 218 whether the measured speed is less than the set speed. If so in step 220 the conveyor speed is increased and if not in step 222 the conveyor speed is decreased, and this process is repeated until the desired conveyor speed is reached. The controller in step 224 provides a flow of heated air to the first zone and in step 226 provides a mixture of heated air and fresh air to zone 2. Thus, two ambient zones can be maintained with a single blower and a single heater.

Periodically, in steps 228,230 the physical conditions that define the ambient conditions in zone 1 and zone 2 are measured and compared in steps 232,234. Adjustments are made in steps 236,238 by, for example, altering the flow rate of heated air or fresh air or the temperature or humidity of the air supplied and the physical conditions are measured again until the desired conditions are met in zone 1 and zone 2. The dryer is operated until the task is complete 240 and the dryer and its associated systems can be shut down.

The dryer of the present invention can be used to simultaneously dry batches of textiles having inks of different curing conditions. For example, one belt can be operated in the first zone to dry an ink applied to a textile in a screen printing operation while the second belt can be operated in the second zone to dry an ink applied in a direct-to-garment printing operation. Thus, screen printers who use both screen printing and direct-to-garment printing presses in a single location can use a single dryer to cure both types of textiles simultaneously.

While the present invention is described in connection with what is presently considered to be the most practical and preferred embodiments, it should be appreciated that the invention is not limited to the disclosed embodiments, and is intended to cover various modifications and equivalent arrangements included within the spirit and scope of the claims. Modifications and variations in the present invention may be made without departing from the novel aspects of the invention as defined in the claims. The appended claims should be construed broadly and in a manner consistent with the spirit and the scope of the invention herein.

We claim:

1. A textile dryer comprising:
a housing defining a chamber having an infeed and an outfeed;
a separation wall extending through the chamber to create a first zone having a first ambient condition and a second zone having a second ambient condition;
a first conveyor extending through the first zone having a first surface for supporting objects in exposure to the first ambient condition;
a second conveyor spaced from the first conveyor and extending through the second zone and having a second surface for supporting objects in exposure to the second ambient condition; and
a controller for independently selecting and maintaining the speed and direction of the first conveyor and the second conveyor and for independently selecting and maintaining the physical conditions of the first ambient condition and the second ambient condition.

2. The dryer of claim 1 wherein the first ambient condition is defined by one or more physical conditions selected from temperature, humidity, pressure, air flow rate(s), and exposure to electromagnetic radiation of a particular frequency.

3. The dryer of claim 1 wherein the ambient condition is defined by a temperature range and a humidity range.

4. The dryer of claim 1 wherein the separation wall is retractable.

5. The dryer of claim 4 wherein the separation wall extends along an entire length of the first conveyor.

6. The dryer of claim 1 wherein the first conveyor is mounted for reciprocal translational motion.

7. The dryer of claim 6 wherein the second conveyor is mounted for reciprocal translational motion.

8. The dryer of claim 1 wherein the first conveyor has a first width and the second conveyor has a second width, the first width being greater than the second width.

9. The dryer of claim 1 further comprising a conduit connecting a source of heated air under pressure to the first zone.

10. The dryer of claim 1 further comprising a fresh air conduit connecting a source of fresh air to the second zone.

11. The dryer of claim 10 further comprising a heated air conduit connecting a source of heated air under pressure to the second zone and a valve for blending the heated air with the fresh air to reach a desired temperature.

12. A textile dryer comprising:
a housing defining a chamber having an infeed, an outfeed and an ambient condition;
a first conveyor extending through the chamber and having a first surface for supporting objects in exposure to the ambient condition;
a second conveyor spaced from the first conveyor and extending through the chamber and having a second surface generally coplanar with the first surface for supporting objects in exposure to the ambient condition; and
a controller for independently selecting and maintaining the speed and direction of the first conveyor and the second conveyor.

13. The dryer of claim 12 wherein the first conveyor system has a conveyor belt having a first width and the second conveyor system has a second width, the first width being greater than the second width.

14. The dryer of claim 12 wherein the first conveyor and the second conveyor are coextensive.

15. The dryer of claim 12 wherein the first conveyor and the second conveyor are coterminous.

16. A method of drying a plurality of textiles comprising:
providing a housing defining a chamber having an infeed end and an opposed outfeed end;
dividing the chamber into a first zone and a second zone with a separation wall;
providing a first conveyor system extending through the chamber and having a belt having a first upper surface for supporting objects;
providing a second conveyor system extending through the chamber and parallel to the first conveyor system and having a belt with a second upper surface generally coplanar with the first upper surface;
providing a source of heated air under pressure;
providing a source of fresh air under pressure;
connecting the source of heated air to the first zone and the second zone through a first conduit;
connecting the source of heated air to the second zone through a second conduit;
controlling the flow rate of heated air into the first zone to maintain a first desired temperature; and
controlling the flow rate of both the heated air and the fresh air into the second zone to maintain a second desired temperature.

17. The method of claim 16 wherein the first conveyor system has a first belt having a first width, and the second conveyor system has a second belt having a second width, the first width being greater than the second width.

18. The method of claim 16 further comprising an electronic controller having a graphical user interface for an operator to select the first desired temperature, the second desired temperature, a belt speed of the first conveyor system, and a belt speed of the second conveyor system.

19. The method of claim 16 wherein the separation wall is retractable.

20. The method of claim 16 further comprising an air knife system in the chamber for providing heated air under pressure over generally an entire length of the first conveyor system.
